(19) United States
(12) Patent Application Publication
(10) Pub. No.: US 2007/0245765 A1
(43) Pub. Date: Oct. 25, 2007

(54) Multi-wine dispenser/the wine box cooler

(76) Inventor: Calvin Casher, Missouri City, TX (US)

Correspondence Address: CALVIN CASHER, 2601 Cartwright Rd., #164, Missouri City, TX, 77459, US

(21) Appl. No.: 11/510,179

(22) Filed: Jan. 22, 2007

Related U.S. Application Data
(60) Provisional application No. 60/711,374, filed on Aug. 26, 2005.

(51) Int. Cl. B67D 5/62; F17C 13/00

(52) U.S. Cl. 62/389; 62/390; 62/457.9

(57) ABSTRACT

Unlike the bottle wines which loss freshness after opening within two (2) days and need to be kept in an expensive wine refrigeration system or the family refrigerator. The refrigerated Wine Box Cooler will keep three (3) to five (5) liter box/pouch wines of other pouched beverages cooled and readily dispensable from the bar/countertop for up to thirty (30) days, This system serves one (1) to three (3) or more units of different wine or pouch containers as easy as tap beer. The refrigerated bottom plate chill the wine or beverage from the bottom up on the basic unit and bottom and side on the advanced unit. During parties this system is transportable and designed to enhance décor, all the time saving the entrepreneur time and at less doubling profit from the convenience of bulk purchasing power.

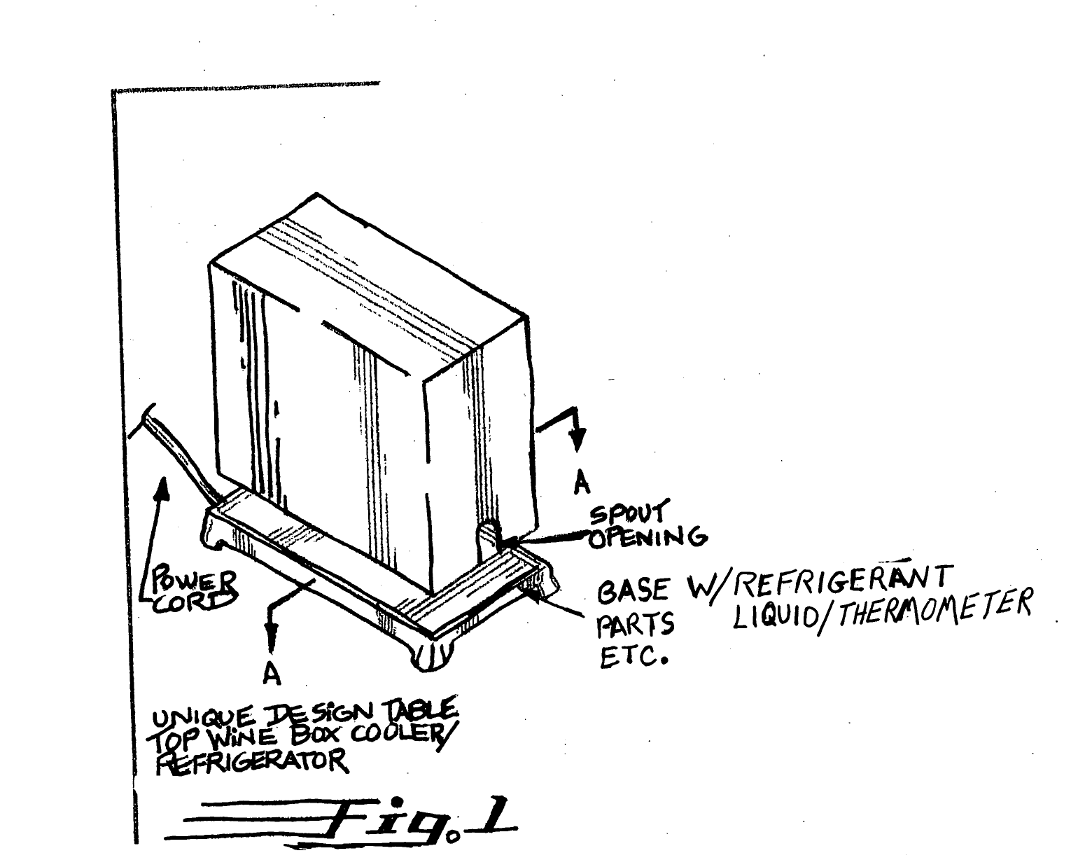

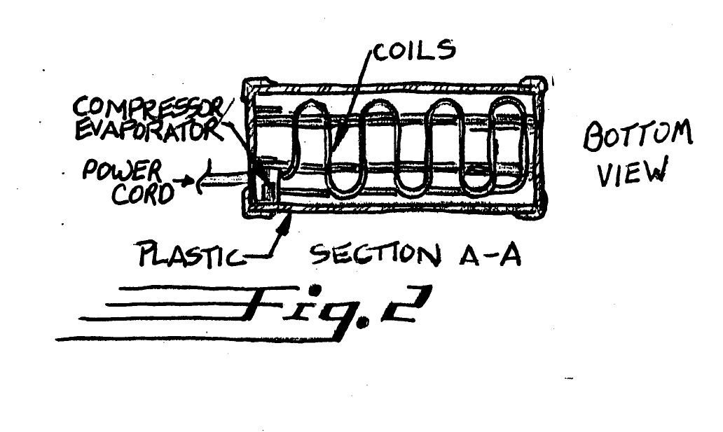

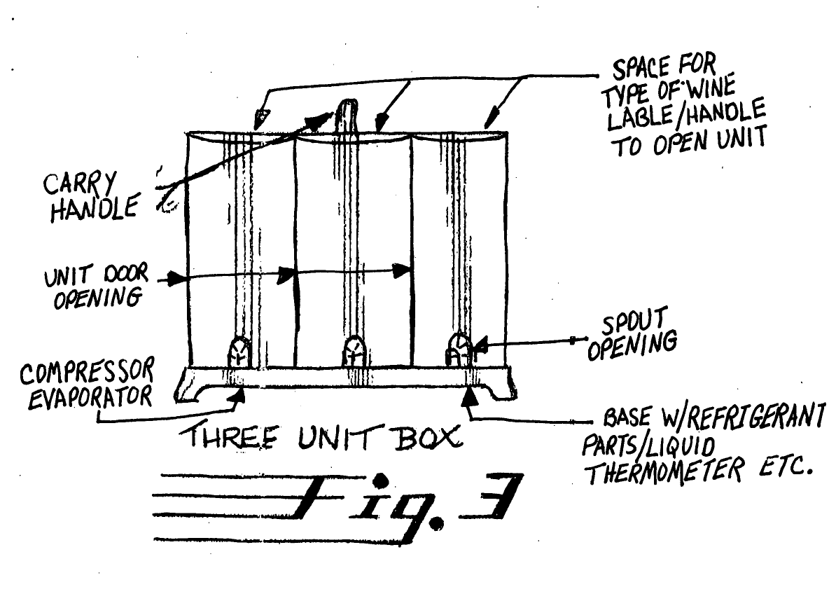

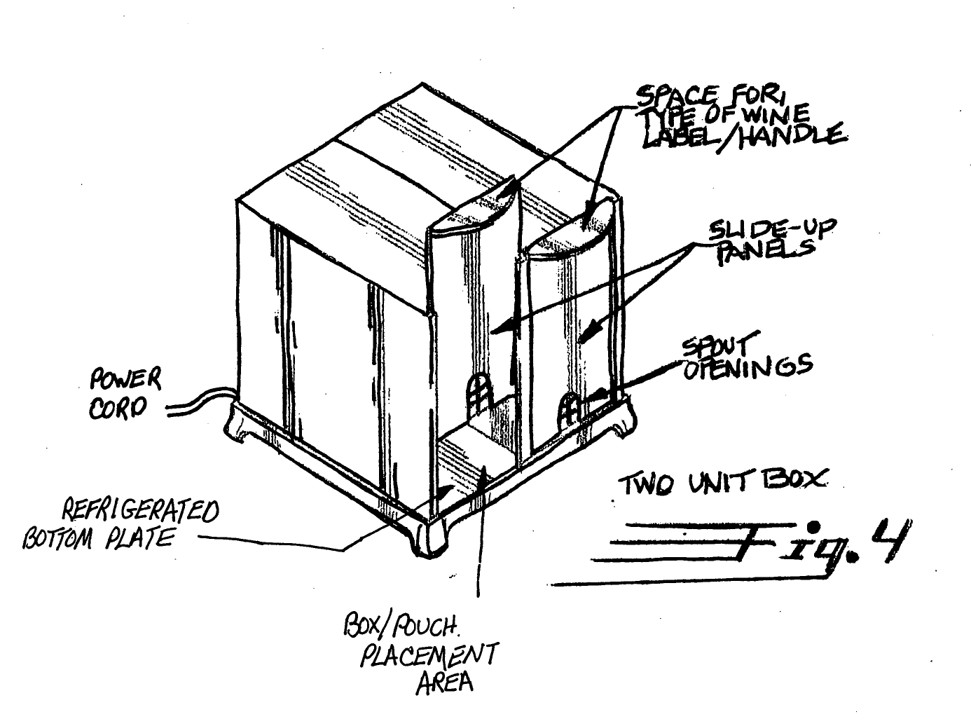

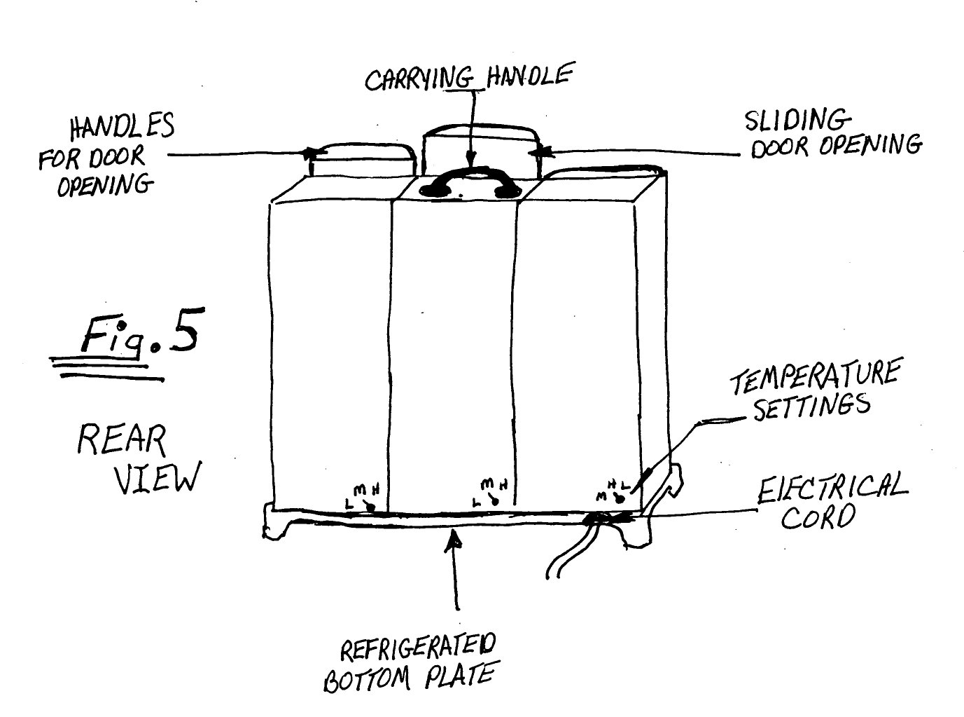

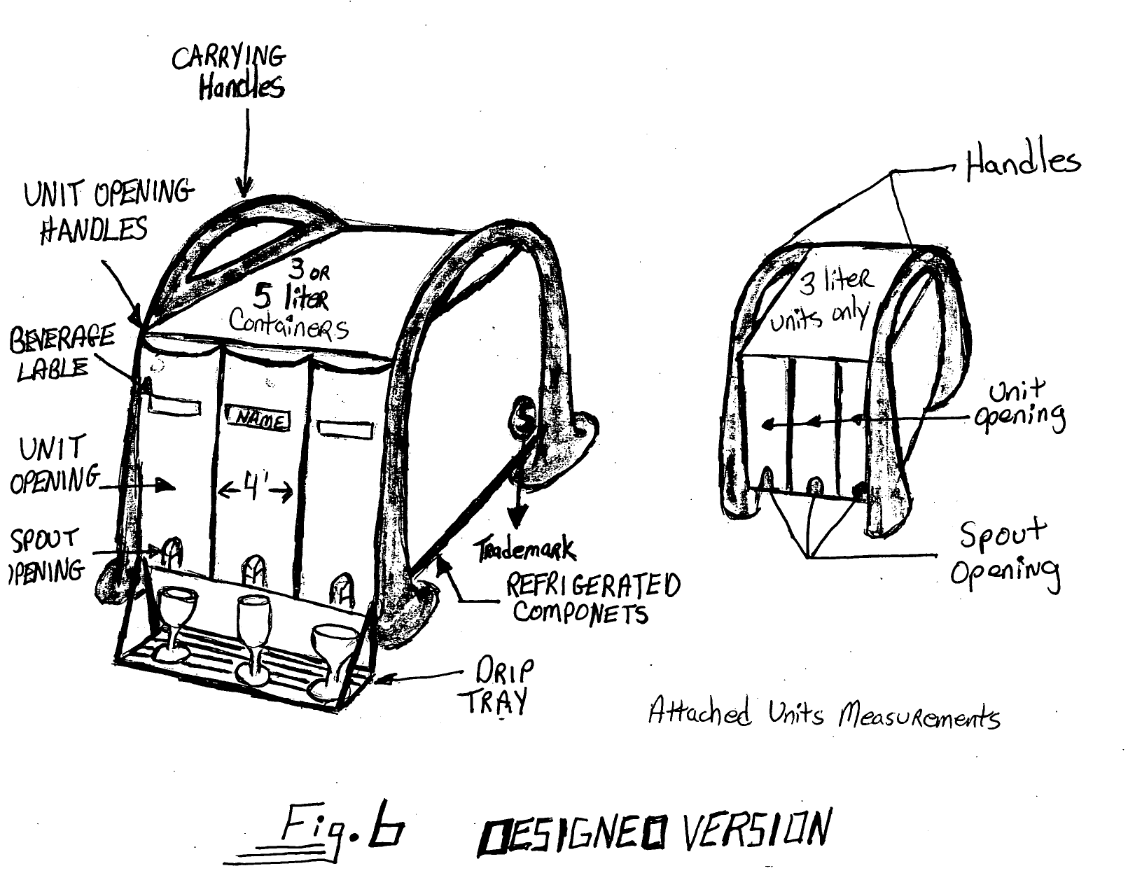

This compact rectangular/square appliance housing measures approximately four (4) inches in width, twelve (12) inches in depth, and twelve (12) inches in height for the single unit, eight (8) inches in width, twelve (12) inches in depth, and twelve (12) inches in height for the double unit, and twelve (12) inches in width, twelve (12) inches in depth, and twelve (12) inches in height for the three unit container.

The unit could be made from plastic such as PVC, ABS, Polycarbonate, or Polyurethane plastics or a metal housing made of aluminum alloys or stainless steel. The refrigerator system spout opening should be constructed with and rubber closure, a layer of insulation, base plate containing a compressor, evaporator, condenser, tubing, and refrigerant, Other features include a cord with a plastic/metal plug, temperature control gauge, and a drip tray. (Please view additional information on page 9-11 of the Product Portfolio.

What is claimed is:

1. The refrigerated container store a variety of Box/Pouched beverages chilled on the countertop/bar which gives access to different beverages as conveniently as tap beer.

2. The refrigerated bottom plate and side plates on upgraded model cool basically from the bottom up and since the spout/dispenser of the box/pouch container is located at the bottom the cooling process is quick to serve chilled beverages;

3. The refrigerated unit holds 3 to 15 liters or more at a constant temperature which prolongs freshness and taste for up to 30 days, and by buying in bulk generates savings/profits to the owner/entrepreneur.
